(19) United States
(12) Patent Application Publication
(10) Pub. No.: US 2003/0142503 A1
(43) Pub. Date: Jul. 31, 2003

(54) Pedestrian protection headlamp

(75) Inventors: Mattias Ericsson, Varberg (SE); Jan-Erik Fritzon, Gothenburg (SE); Gunnar Bringfeldt, Stenungsund (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Global Technologies, Inc., Dearborn, MI

(21) Appl. No.: 09/683,654

(22) Filed: Jan. 30, 2002

(51) Int. Cl. B60Q 1/00

(52) U.S. Cl. 362/487

(57) ABSTRACT

A pedestrian protection headlamp assembly for a motor vehicle allows the headlamp to yield rearward in a controlled, energy-absorbing manner in order to cushion the impact experienced by a pedestrian struck by the vehicle. The headlamp assembly comprises a headlamp mountable to the vehicle to form a front corner of the vehicle, a pivot mechanism disposed adjacent the outboard end of the headlamp for mounting the headlamp to the vehicle and defining a generally vertical pivot axis about which the headlamp may rotate relative to the vehicle, and a damper disposed inboard of the pivot mechanism. When a pedestrian strikes the headlamp, the damper compresses and allows controlled rearward movement of the inboard end of the headlamp as the headlamp rotates about the pivot mechanism. The damper is located adjacent an inboard end of the headlamp and a trigger prevents rotation of the headlamp about the pivot when the force applied to the headlamp is below a threshold value. When the threshold amount of force is reached, the trigger releases to permit the headlamp to rotate rearward. The upper end of the pivot axis is tilted toward the rear of the vehicle, to provide for optimum absorption of impact energy when the direction of pedestrian impact is inclined downwardly from the horizontal.

### BACKGROUND OF INVENTION

This invention relates to headlamps for automotive vehicles and, more particularly, to a headlamp that absorbs impact forces in order to lessen the severity of injury to a pedestrian struck by the vehicle.

In recent years, increased importance has been placed on ways in which automotive vehicles can be designed to minimize the amount of injury suffered by a pedestrian when struck by a vehicle. To achieve the greatest overall reduction in the probability and severity of pedestrian injury, all components of the vehicle that may contact a pedestrian during an impact must be designed to be “pedestrian friendly.”

For styling, manufacturing, and light projection reasons, some motor vehicles have headlamps that form the front corners of the vehicle, wrapping around the corners. This allows a single headlamp unit to include the main headlamp reflectors, turn signals, and other lamps. The headlamps may also be located relatively far forward, with their front surface located only a short distance behind the bumper of the vehicle. When headlamps are in this position on the vehicle, it is important that they be designed with the pedestrian in mind.

U.S. Pat. No. 4,475,148 teaches a headlamp that pivots about a horizontal axis when it is struck in order to cushion a pedestrian impact. This configuration, however, results in only the upper portion of the headlamp being able to move rearward, with any impact near the bottom of the headlamp being substantially uncushioned. Also, because the headlamp has a short vertical dimension, the distance that the upper edge of the headlamp is able to move is relatively small, limiting the amount of energy that can be dissipated.

### SUMMARY OF INVENTION

The invention provides a pedestrian protection headlamp assembly for a motor vehicle which allows the headlamp to yield rearward in a controlled, energy-absorbing manner in order to cushion the impact experienced by a pedestrian struck by the vehicle. The headlamp assembly comprises a headlamp mountable to the vehicle to form a front corner of the vehicle, a pivot mechanism disposed adjacent the outboard end of the headlamp for mounting the headlamp to the vehicle and defining a generally vertical pivot axis about which the headlamp may rotate relative to the vehicle, and a damper disposed inboard of the pivot mechanism. When a pedestrian strikes the headlamp, the damper compresses and allows controlled rearward movement of the inboard end of the headlamp as the headlamp rotates about the pivot mechanism.

In a preferred embodiment of the invention disclosed herein, the damper is located adjacent an inboard end of the headlamp and a trigger prevents rotation of the headlamp about the pivot when the force applied to the headlamp is below a threshold value. When the threshold amount of force is reached, the trigger releases to permit the headlamp to rotate rearward.

According to another feature of the invention, the upper end of the pivot axis is tilted toward the rear of the vehicle. This orientation of the pivot axis provides for optimum absorption of impact energy when the direction of pedestrian impact is inclined downwardly from the horizontal.

According to another feature of the invention, the trigger is manually releasable and the pivot mechanism is operative to allow the headlamp to rotate forward with respect to the vehicle in order to provide access to the rear surface of the headlamp for repair or maintenance.

### BRIEF DESCRIPTION OF DRAWINGS

FIG. 1 is a perspective partial view of a headlamp assembly according to the invention on a vehicle.

FIG. 2 is a top view the invention headlamp in a normal operating condition.

FIG. 3 is a top view the invention headlamp in a compressed condition.

FIG. 4 is a top view the invention headlamp in a servicing condition.

### DETAILED DESCRIPTION

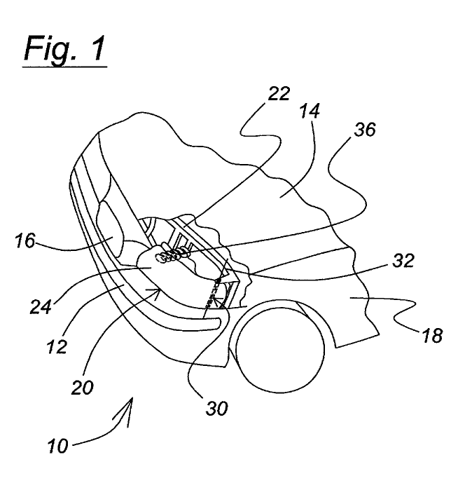

As seen in FIG. 1, a front quarter of an automotive vehicle 10 includes a bumper 12, a hood 14, a grill 16, a fender 18, and a pedestrian protection headlamp assembly 20. A grill opening reinforcement 22 is located behind grill 16 and provides structural support for the grill and other components.

Headlamp assembly 20 is located at the outboard corner of the vehicle front quarter and wraps around the corner. As best seen in FIG. 2, headlamp assembly 20 preferably includes a headlamp 24 having a transparent lens 26 enclosing at least one bulb/reflector 28 for projecting a light beam. Many bulbs and/or reflectors may be contained within the headlamp 26 as called for by styling or functional considerations.

Headlamp assembly 20 further comprises a pivot mechanism 30 disposed adjacent the outboard end of headlamp 24 and defining a generally vertical pivot axis 32 about which the headlamp 24 may pivot with respect to the vehicle. As used herein, the terms “outboard” and “inboard” are with respect to the vehicle as a whole and refer to relative distance from a longitudinal centerline of the vehicle. Pivot mechanism 30 preferably mounts headlamp 24 to grille opening reinforcement 22, but may mount to any vehicle structure adjacent the outboard end of the headlamp. Pivot mechanism 30 may comprise a rod (not shown) passing through the headlamp 24 and supported adjacent its upper and lower ends, or any other appropriate pivot design may be used.

An energy-absorbing damper 36 is disposed between the rear surface of headlamp 24 and extends rearward to the vehicle structure. Damper 36 is preferably located adjacent the inboard end of headlamp 24 and permits controlled rearward movement of the inboard end of the headlamp as the headlamp rotates about pivot mechanism 30. Damper 36 may be pneumatic, hydraulic, mechanical, or any other appropriate type of device for absorbing or dissipating kinetic energy.

A trigger 38 connects the inboard end of headlamp 24 to grill 16, hood 14, bumper 12, or other adjacent vehicle structure. Trigger 38 holds headlamp 24 securely to the adjacent vehicle structure so that the headlamp 24 is not able to rotate about pivot mechanism 30 until a threshold level of force is exerted on the trigger. When the threshold level of force is reached, trigger 38 releases and permits the inboard end of headlamp 24 to move rearward.

Trigger 38 may, for example, comprise a first ring-like fitting 40 secured to grill 16, a second ring-like fitting 42 secured to headlamp 24 so as to be in alignment with the first fitting when the headlamp is in the normal operating condition (see FIG. 2), and a shear pin 44 passing through the two fittings. Alternatively, trigger 38 may be collocated with and/or integrated with damper 36.

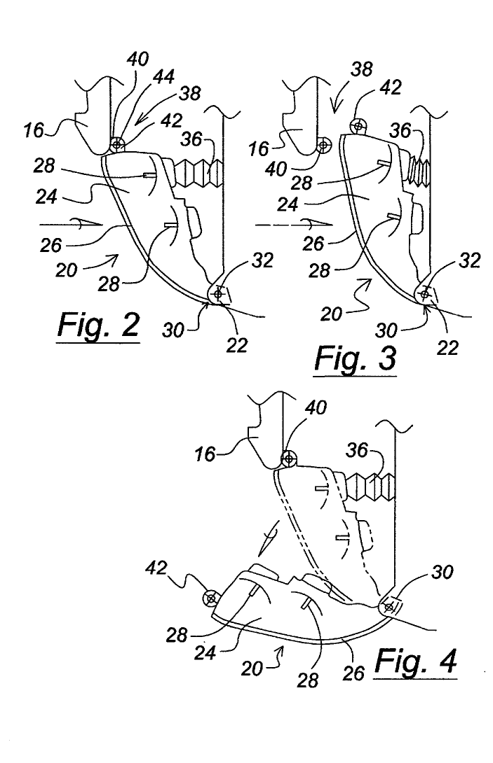

When a rearward force is applied to the invention headlamp assembly 20 by striking a pedestrian, trigger 38 releases headlamp 24 and the inboard end of the headlamp is forced rearward against the resistance provided by damper 36 as the damper compresses. See FIG. 3. The controlled movement caused by damper 36 cushions the impact delivered to the pedestrian by headlamp 24, thereby reducing the likelihood and/or severity of injury. Trigger 38 may be a single-use device that must be replaced after it has released headlamp 24, or it may be a resettable device that functions multiple times without need for replacement.

The generally vertical orientation of pivot axis 32 and its location adjacent the outboard end of headlamp 24 yields two main advantages. First, because headlamp 24 is relatively wide it is able to move rearward a substantial distance and so absorb a significant amount of impact energy. For a headlamp used on an average sized passenger sedan, a rotation of approximately 6° about pivot axis 32 corresponds to a rearward movement of approximately 45 mm adjacent the inboard end of the headlamp 24. Second, the headlamp assembly 20 is able to absorb an impact that takes place anywhere over the vertical extent of the headlamp 24. This results in the headlamp assembly 20 providing injury reduction benefits in the case of a lower leg impact as well as an upper leg impact.

For optimum absorption of impact energy, the pivot axis 32 should be oriented perpendicular to the direction of impact by a pedestrian on the headlamp 24. Depending upon the vehicle geometry and the stature of the pedestrian, the expected direction of pedestrian impact may be inclined downwardly from the horizontal. With this in mind, it has been found beneficial to move the upper end of the pivot axis 32 toward the rear of the vehicle so that the axis is tilted to the rear by an angle of from approximately 10° to approximately 30°.

Trigger 38 may also be released manually and damper 36 detached from headlamp 24 so that the headlamp 24 can be rotated forward, as shown in FIG. 4. This forward rotation allows access to the rear surface of headlamp 24 so that repairs and/or maintenance can be performed.

Headlamp 24 may be designed to break, yield, flex, crush, and/or deform under the force of a pedestrian impact in order to absorb additional impact energy.

While the best modes for carrying out the invention have been described in detail, those familiar with the art to which this invention relates will recognize various alternative designs and embodiments for practicing the invention as defined by the appended claims.

1. A pedestrian protection headlamp assembly for a motor vehicle comprising:
a headlamp mountable to the vehicle to form a front corner of the vehicle, the headlamp having an inboard end and an outboard end;
a pivot mechanism disposed adjacent the outboard end of the headlamp for mounting the headlamp to the vehicle, the pivot mechanism defining a generally vertical pivot axis about which the headlamp may rotate relative to the vehicle such that the inboard end of the headlamp moves rearward; and
a damper disposed inboard of the pivot mechanism for connecting the headlamp to the vehicle and allowing controlled rearward movement of the inboard end of the headlamp during rotation of the headlamp about the pivot mechanism in response to a force applied to the headlamp.

2. The apparatus according to claim 1 wherein an upper end of the pivot axis is inclined rearward from vertical.

3. The apparatus according to claim 2 wherein the upper end of the pivot axis is inclined rearward from vertical by an angle between approximately 10 degrees and approximately 30 degrees.

4. The apparatus according to claim 1 wherein the pivot mechanism is adapted to secure the headlamp to a grill opening reinforcement.

5. The apparatus according to claim 1 wherein the damper is adjacent an inboard end of the headlamp.

6. The apparatus according to claim 1 further comprising a trigger preventing rotation of the headlamp about the pivot when the force applied to the headlamp is below a threshold value and permitting the headlamp to rotate rearward when the threshold value is reached.

7. The apparatus according to claim 6 wherein the trigger is disposed adjacent the inboard end of the headlamp and connects the headlamp to the vehicle.

8. The apparatus according to claim 6 wherein the trigger comprises a shear pin.

9. The apparatus according to claim 6 wherein the trigger is manually releasable and after the trigger is released the pivot mechanism is operative to allow the headlamp to rotate forward with respect to the vehicle in order to provide access to a rear surface of the headlamp.

10. The apparatus according to claim 1 wherein the headlamp is adapted to absorb energy by deforming during an impact.

11. A motor vehicle having a pedestrian protection headlamp assembly comprising:
a headlamp mounted to the vehicle to form a front corner of the vehicle, the headlamp having an inboard end adjacent a front of the vehicle and an outboard end adjacent a side of the vehicle;
a pivot mechanism connecting the outboard end of the headlamp to the vehicle, the pivot mechanism defining a generally vertical pivot axis about which the headlamp may rotate relative to the vehicle; and
a damper disposed inboard of the pivot mechanism and connecting the headlamp to the vehicle, the damper allowing controlled rearward movement of the inboard end of the headlamp during rotation of the headlamp about the pivot mechanism in response to a force applied to the headlamp.

12. The apparatus according to claim 11 wherein an upper end of the pivot axis is inclined rearward from vertical.

13. The apparatus according to claim 12 wherein the upper end of the pivot axis is inclined rearward from vertical by an angle between approximately 110 degrees and approximately 30 degrees.

14. The apparatus according to claim 11 wherein the pivot mechanism secures the headlamp to a grill opening reinforcement.

15. The apparatus according to claim 11 wherein the damper is adjacent an inboard end of the headlamp.

16. The apparatus according to claim 11 further comprising a trigger connecting the headlamp to the vehicle to prevent rotation of the headlamp about the pivot when the force applied to the headlamp is below a threshold value, and permit the headlamp to rotate rearward when the threshold value is reached.

17. The apparatus according to claim 16 wherein the trigger is disposed adjacent the inboard end of the headlamp.

18. The apparatus according to claim 16 wherein the trigger comprises a shear pin.

19. The apparatus according to claim 16 wherein the trigger is manually releasable and after the trigger is released the pivot mechanism is operative to allow the headlamp to rotate forward with respect to the vehicle in order to provide access to a rear surface of the headlamp.

20. The apparatus according to claim 11 wherein the headlamp is adapted to absorb energy by deforming during an impact.
